(19) United States
(12) Patent Application Publication
(10) Pub. No.: US 2025/0038268 A1
(43) Pub. Date: Jan. 30, 2025

(54) ELECTROLYTE SOLUTION AND BATTERY

(71) Applicant: ZHUHAI COSMX BATTERY CO., LTD., Zhuhai (CN)

(72) Inventors: Hai WANG, Zhuhai (CN); Suli LI, Zhuhai (CN)

(73) Assignee: ZHUHAI COSMX BATTERY CO., LTD., Zhuhai (CN)

(21) Appl. No.: 18/900,826

(22) Filed: Sep. 29, 2024

Related U.S. Application Data
(63) Continuation of application No. PCT/CN2023/132459, filed on Nov. 17, 2023.

(30) Foreign Application Priority Data
Nov. 18, 2022 (CN) 202211449520.1
Dec. 13, 2022 (CN) 202211601620.1

(51) Int. Cl. H01M 10/0567

(52) U.S. Cl. CPC H01M 10/0567

(57) ABSTRACT

Disclosed are an electrolyte solution and a battery. The electrolyte solution in the present disclosure includes an organic solvent, a lithium salt, an additive A, an additive B, and an additive C, where the additive A is carbon-linked disulfonate; the additive B is a polycyano nitrile compound; and the additive C is a bis(fluorosulfonyl)imide salt. The electrolyte solution can improve high-temperature performance of the battery, involves a simple process and low costs, and achieves a good protection effect.

### CROSS-REFERENCE TO RELATED APPLICATIONS

This application is a continuation of International Application No. PCT/CN2023/132459, filed on Nov. 17, 2023, which claims priority to Chinese Patent Application No. 202211449520.1, filed on Nov. 18, 2022, and Chinese Patent Application No. 202211601620.1, filed on Dec. 13, 2022. All of the aforementioned patent applications are hereby incorporated by reference in their entireties.

### TECHNICAL FIELD

The present disclosure relates to the field of battery technologies, and specifically, to an electrolyte solution and a battery.

### BACKGROUND

With advantages of a high operating voltage, high energy density, a long life, being environmentally friendly, and the like, lithium-ion batteries are widely used in fields of 3C digital products, electric tools, electric vehicles, and the like. Especially in the 3C digital field, a development trend of lighter and thinner mobile electronic devices (such as a smartphone and a mobile power supply) in recent years has made the lithium-ion batteries increasingly popular.

The lithium-ion battery is a rechargeable battery that works primarily through movement of lithium ions between positive and negative electrodes. During charging and discharging, Li⁺ is intercalated and unintercalated between the two electrodes: During charging, Li⁺ is unintercalated from the positive electrode, and is intercalated into the negative electrode by using an electrolyte solution, and the negative electrode is in a lithium-rich state; and the opposite is true during discharging. As one of main materials in the lithium-ion battery, the electrolyte solution plays an indispensable role and is known as the “blood” of the lithium-ion battery. However, the most critical part in the electrolyte solution of the lithium-ion battery is an additive, such as a negative electrode film forming additive, a positive electrode film forming additive, a stabilizer, a dehydrant, and an acid scavenger.

Generally, a sulfur-containing additive in the electrolyte solution reduces impedance of the battery, thereby improving high-temperature performance and low-temperature performance of the battery. As a representative additive containing sulfur elements, a structural formula of 1,3-propane sultone (PS) is as follows:

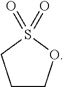

PS is a film forming additive that reduces impedance of the battery. However, due to a carcinogenic hazard of the additive PS, the European Union is particularly strict in use and control of the additive. After the electrolyte solution is injected into the battery and a product is manufactured, random inspections are carried out to test a content of the additive PS (the Reach testing).

However, another typical additive containing sulfur element such as ethylene sulfate (DTD) has poor heat stability. If there is no stabilizer, an acid value and chromaticity of the electrolyte solution deteriorate, thereby affecting high-temperature performance of the battery.

Therefore, it is urgent to develop an additive that can replace an additive such as PS and may improve high-temperature performance of the battery.

### SUMMARY

In view of this, the present disclosure provides an electrolyte solution and a battery. The electrolyte solution can improve high-temperature security performance of the battery, involves a simple process and low costs, and achieves a good protection effect.

To achieve the foregoing objectives, the present disclosure provides following technical solutions.

The present disclosure provides an electrolyte solution, where the electrolyte solution includes an organic solvent, a lithium salt, an additive A, an additive B, and an additive C, where
the additive A is carbon-linked disulfonate;
the additive B is a polycyano nitrile compound; and
the additive C is a bis(fluorosulfonyl)imide salt.

The present disclosure further provides a battery, including the foregoing electrolyte solution.

Compared with a conventional technology, the present disclosure has the following beneficial effects.

The additive A in the present disclosure is an unsaturated ring compound containing a sulfonic acid group, and a functional group, that is, the contained sulfonic acid group, may be alkyl sulfonate lithium RSO₃Li on a surface of the negative electrode. In this case, ionic conductivity of a SEI film may be improved. In addition, ring carbonate or an imidazolidinone structure contained in the additive A may be polymerized on the surface of the negative electrode and participate in formation of the SEI film, thereby improving high-temperature storage and cycling performance of the battery. In addition, under high pressure, the additive A can decompose into a film at the positive electrode, thereby reducing a content of LiF, and improving interfacial lithium conductivity. In addition, decomposition of LiPF₆ and the electrolyte solution on the surface of the positive electrode is inhibited, thereby improving rate performance and cycling stability of the battery.

In a structure of the additive B in the present disclosure, electron-rich property of a cyano group N (—C≡N) is firmly complexed with electron-deficient Co on a surface of LiCoO₂ (LCO), so that erosion and dissolution of Co ions in the positive electrode material by the electrolyte solution or another corrosive byproduct can be inhibited, thereby slowing down damage of the Co ions to the interface of the negative electrode, and improving high-temperature cycling performance of the battery. In addition, the additive B is added to the electrolyte solution together with the additive A for combined use. Since the additive A can slow down the damage of the Co ions to the interface of the negative electrode, the film forming stability of the additive A after a film is formed at the negative electrode can be further improved, and high-temperature storage and cycling performance of the battery can be further improved. In particular, when the additive B is a combination of ADN and HTCN, a combination of succinonitrile and HTCN, or a combination of succinonitrile and ADN, a combination with the additive A has an optimum effect and film forming stability at the negative electrode is optimum.

Further, the additive C (the bis(fluorosulfonyl)imide salt) in the present invention is a positive electrode protection additive that can continuously perform repairment on the surface of the positive electrode in a later stage of a cycle, thereby improving film forming stability of the additive A at the positive electrode, and further improving high-temperature performance of the battery in the later stage of the cycle. Furthermore, the combination of the additive A, the additive B, and the additive C in the present disclosure meets the following relational expression:

0.36≤(C_{B}+0.5C_{A})/(C_{C}−0.5C_{A})≤4,

where C_{A} is a mass percentage value of the additive A, C_{B} is a mass percentage value of the additive B, and C_{C} is a mass percentage value of the additive C, where 1≤A≤4, 0.1≤B≤3, and 2≤C≤7.

When the foregoing relational expression is met, it can be ensured that the additive A, the additive B, and the additive C all reach appropriate relative percentages, so that both the positive and negative electrodes achieve optimum film forming stability. In this case, a barrier effect is effectively achieved, and optimum security performance of the battery is significantly achieved.

### DETAILED DESCRIPTION OF THE EMBODIMENTS

The present disclosure provides an electrolyte solution and a battery. A person skilled in the art can refer to content of the present disclosure and appropriately improve process parameters to implement the present disclosure. It should be particularly noted that all similar replacements and modifications are obvious to a person skilled in the art and are considered to be included in the present disclosure. The method and application of the present disclosure have been described by preferred examples. The relevant person can obviously modify or appropriately change and combine the method and application of the present disclosure without departing from the content, spirit, and scope of the present disclosure, to implement and apply the technology in the present disclosure.

The present disclosure provides an electrolyte solution, where the electrolyte solution includes an organic solvent, a lithium salt, an additive A, an additive B, and an additive C, where
the additive A is carbon-linked disulfonate;
the additive B is a polycyano nitrile compound; and
the additive C is a bis(fluorosulfonyl)imide salt.

In the present disclosure, the “carbon-linked disulfonate” refers to at least two ring sulfonate compounds. In a specific implementation of the present disclosure, the two ring sulfonate compounds are symmetrical, can form a film on a negative electrode before a solvent, and can also form a film on a positive electrode, thereby reducing a LiF content, and improving conductivity of lithium ions.

In the present disclosure, the “polycyano nitrile compound” refers to a nitrile compound having two or more cyano groups.

Preferably, the additive A has a following general structural formula:

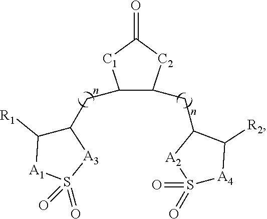

where R₁ and R₂ are independently selected from.

an alkane group of C1 to C20, an alkene group of C1 to C20, and an alkyne group of C1 to C20 each substituted or unsubstituted by halogen,
a cycloalkyl group of C3 to C20 substituted or unsubstituted by halogen,
a phenyl group substituted or unsubstituted by halogen,
a biphenylyl group substituted or unsubstituted by halogen,
a benzene alkyl group of C6 to C26 substituted or unsubstituted by halogen,
a polycyclic aromatic hydrocarbon group of C6 to C26 substituted or unsubstituted by halogen, and
a hydrogen or halogen.

Preferably, R₁ and R₂ are independently selected from:
an alkane group of C1 to C8, an alkene group of C1 to C8, and an alkyne group of C1 to C8 each substituted or unsubstituted by halogen,
a cycloalkyl group of C3 to C8 substituted or unsubstituted by halogen,
a phenyl group substituted or unsubstituted by halogen,
a biphenylyl group substituted or unsubstituted by halogen,
a benzene alkyl group of C6 to C8 substituted or unsubstituted by halogen,
a polycyclic aromatic hydrocarbon group of C10 to C14 substituted or unsubstituted by halogen, and
a hydrogen or halogen.

Preferably, R₁ and R₂ are independently selected from:
an alkane group of C1 to C6 substituted or unsubstituted by halogen, and
a hydrogen or halogen.

Preferably, R₁ and R₂ are independently selected from: hydrogen, methyl, ethyl, n-propyl, isopropyl, n-butyl, and tert-butyl.

Where A₁, A₂, A₃, A₄, C₁, and C₂ represent atoms independent of each other, and are independently selected from C, S, N, and O.

Preferably, A₁ and A₄ are independently selected from C, N, and O.

Preferably, A₂, A₃, C₁, and C₂ are independently selected from N and O.

N is a quantity of carbon atoms that ranges from 0 to 2.

Preferably, n is 1.

In a specific example provided in the present disclosure, the additive A includes at least one of following structural formulas 1 to 12:

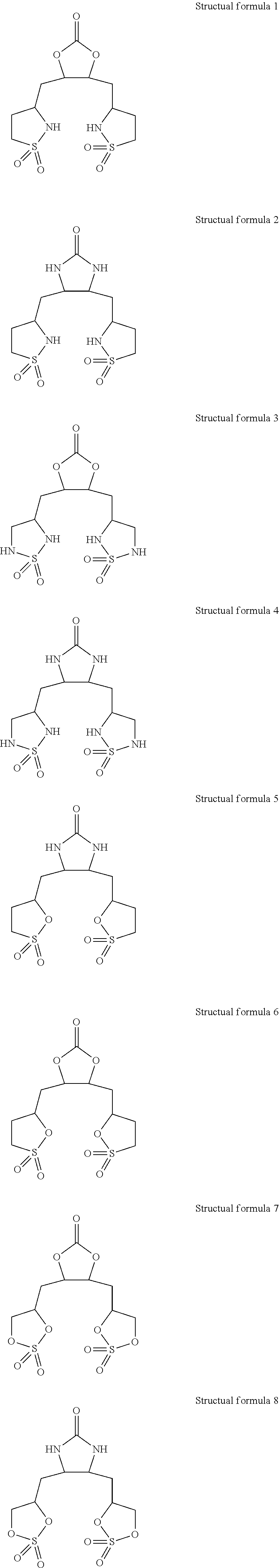

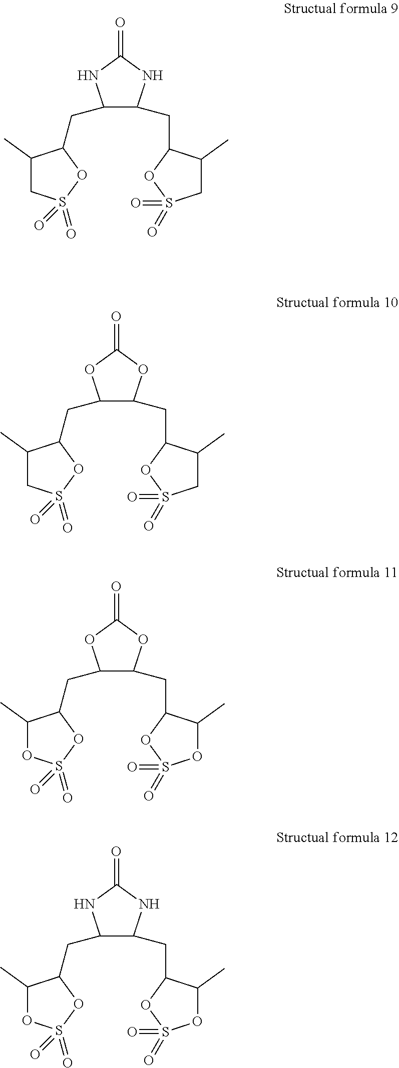

Preferably, the polycyano nitrile compound includes at least one of succinonitrile, glutaronitrile, adiponitrile (ADN), suberonitrile, sebaconitrile, 3-methoxypropionitrile, ethylene glycol bis(propionitrile) ether, 1,3,6-hexanetricarbonitrile (HTCN), 1,2,3-tris-(2-cyanoethoxy)propane, 1,3,5-pentanetricarbonitrile, 2,2-difluorosuccinonitrile, 2-fluoroadiponitrile, or tricyanobenzene.

Preferably, the polycyano nitrile compound includes at least one of a composition of adiponitrile and 1,3,6-hexanetricarbonitrile, a composition of succinonitrile and 1,3,6-hexanetricarbonitrile, or a composition of succinonitrile and adiponitrile.

The inventor of the present disclosure has found that when the polycyano nitrile compound includes the foregoing combination, the polycyano nitrile compound may be better complexed on a surface of a positive electrode plate, has a strong coordination effect with electron-deficient Co on a surface of LiCoO₂ (LCO), and may inhibit dissolution of Co ions in a positive electrode material, thereby slowing down damage to an interface of a negative electrode. In addition, the additive A can be preferentially reduced at the negative electrode to form a good interface protection film. In addition, the combination of the polycyano nitrile compounds can be used in combination with the additive A, to further improve film forming stability of the negative electrode, thereby further improving high-temperature cycling performance of the battery. Further, preferably, the polycyano nitrile compound includes adiponitrile and 1,3,6-hexanetricarbonitrile.

Preferably, a mass ratio of adiponitrile to 1,3,6-hexanetricarbonitrile is (1 to 100):(1 to 100). “1 to 100” may be, for example, 1, 5, 10, 20, 30, 40, 50, 60, 70, 80, 90, 100.

Preferably, a mass ratio of adiponitrile to 1,3,6-hexanetricarbonitrile is (1 to 10):(1 to 10). “1 to 10” may be, for example, 1, 2, 3, 4, 5, 6, 7, 8, 9, 10.

In a specific example provided in the present disclosure, a mass ratio of adiponitrile to 1,3,6-hexanetricarbonitrile is 1:1.

Preferably, a structural formula of the bis(fluorosulfonyl)imide salt is shown below:

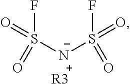

where R₃ is selected from one of Li, Na, K, Rb, Cs, or Fr.

Preferably, the bis(fluorosulfonyl)imide salt includes at least one of lithium bis(fluorosulfonyl)imide, sodium bis(fluorosulfonyl)imide, potassium bis(fluorosulfonyl)imide, rubidium bis(fluorosulfonyl)imide, or cesium bis(fluorosulfonyl)imide.

A structural formula of lithium bis(fluorosulfonyl)imide is:

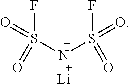

A structural formula of sodium bis(fluorosulfonyl)imide is:

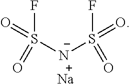

A structural formula of potassium bis(fluorosulfonyl)imide is:

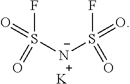

A structural formula of rubidium bis(fluorosulfonyl)imide is:

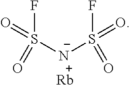

A structural formula of cesium bis(fluorosulfonyl)imide is:

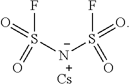

Preferably, based on a total weight of the electrolyte solution, a content of the additive A ranges from 0.1 wt % to 5.0 wt %, for example, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.2 wt %, 1.3 wt %, 1.5 wt %, 1.6 wt %, 1.8 wt %, 2 wt %, 2.2 wt %, 2.4 wt %, 2.5 wt %, 2.6 wt %, 2.8 wt %, 3 wt %, 3.3 wt %, 3.5 wt %, 3.8 wt %, 4 wt %, 4.2 wt %, 4.5 wt %, 4.8 wt %, or 5.0 wt %.

Preferably, a content of the additive A ranges from 1.0 wt % to 4.0 wt %.

Preferably, based on a total weight of the electrolyte solution, a content of the additive B ranges from 0.1 wt % to 5.0 wt %, for example, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.2 wt %, 1.3 wt %, 1.5 wt %, 1.6 wt %, 1.8 wt %, 2 wt %, 2.2 wt %, 2.4 wt %, 2.5 wt %, 2.6 wt %, 2.8 wt %, 3 wt %, 3.3 wt %, 3.5 wt %, 3.8 wt %, 3.9 wt %, 4 wt %, 4.2 wt %, 4.5 wt %, 4.8 wt %, or 5.0 wt %.

Preferably, a content of the additive B ranges from 0.1 wt % to 3.9 wt %.

More preferably, a content of the additive B ranges from 0.1 wt % to 3.0 wt %.

Preferably, based on a total weight of the electrolyte solution, a content of the additive C ranges from 0.5 wt % to 10 wt %, for example, 0.5 wt %, 0.6 wt %, 0.7 wt %, 0.8 wt %, 0.9 wt %, 1 wt % 1.2 wt %, 1.3 wt %, 1.5 wt %, 1.6 wt %, 1.8 wt %, 2 wt %, 2.2 wt %, 2.4 wt %, 2.5 wt %, 2.6 wt %, 2.8 wt %, 3 wt %, 3.3 wt %, 3.5 wt %, 3.8 wt %, 4 wt %, 4.2 wt %, 4.5 wt %, 4.8 wt %, 5 wt %, 6 wt %, 7 wt %, 8 wt %, 9 wt %, or 10 wt %.

Preferably, a content of the additive C ranges from 2.0 wt % to 7.0 wt %.

Preferably, the electrolyte solution meets a following relational expression:

0.36≤(C_{B}+0.5C_{A})/(C_{C}−0.5C_{A})≤4, for example, 0.36,0.5,1,1.5,2,2.5,3,3.5,4;

where C_{A} is a mass percentage value of the additive Ain the electrolyte solution, C_{B} is a mass percentage value of the additive B in the electrolyte solution, and C_{C} is a mass percentage value of the additive C in the electrolyte solution, where 1≤C_{A}≤4, 0.1≤C_{B}≤3, and 2≤C_{C}≤7. The inventor of the present disclosure has found that when the relational expression of C_{A}, C_{B}, and C_{C} is reasonably controlled within such a range, it can be ensured that the additive A, the additive B, and the additive C all reach appropriate relative percentages, so that both positive and negative electrodes achieve optimum film forming stability, that is, a combination of the additives A, B, and C has an optimum protection effect. In this case, a barrier effect can be effectively achieved, and security performance is significantly improved.

Preferably, the electrolyte solution further includes an additive D, and the additive D includes at least one of fluoroethylene carbonate, 1-propene 1,3-sultone, ethylene sulfate, lithium difluorooxalatoborate, lithium difluorophosphate, or lithium bisoxalatodifluorophosphate. The inventor of the present disclosure has found that further adding the additive D may improve wettability of a negative electrode plate, and can also generate a synergistic effect with the additive A, to further inhibit a side reaction between a negative electrode active material and the electrolyte solution, thereby further improving high-temperature storage and cycling performance of the battery. Preferably, the additive D includes fluoroethylene carbonate and 1-propene 1,3-sultone. A reason for selecting the two ester compounds as the additive D is that when fluoroethylene carbonate and 1-propene 1,3-sultone are used in combination, an effect of inhibiting the side reaction between the negative electrode active material and the electrolyte solution is better.

Preferably, based on a total weight of the electrolyte solution, a content of fluoroethylene carbonate ranges from 1 wt % to 10 wt %, for example, is 1 wt %, 2 wt %, 3 wt %, 4 wt %, 5 wt %, 6 wt %, 7 wt %, 8 wt %, 9 wt %, or 10 wt %.

Preferably, based on a total weight of the electrolyte solution, a content of 1-propene 1,3-sultone ranges from 1 wt % to 3 wt %, for example, is 1 wt %, 1.2 wt %, 1.3 wt %, 1.5 wt %, 1.6 wt %, 1.8 wt %, 2 wt %, 2.2 wt %, 2.4 wt %, 2.5 wt %, 2.6 wt %, 2.8 wt %, or 3 wt %.

Preferably, the lithium salt is selected from at least one of lithium hexafluorophosphate (LiPF₆), lithium difluorophosphate (LiPO₂F2), lithium difluorooxalatoborate (LiDFOB), lithium bis(trifluoromethylsulfonyl)imide, lithium difluorobis(oxalato)phosphate, lithium tetrafluoroborate, lithium bis(oxalatoborate), lithium hexafluoroantimonate, lithium hexafluoroarsenate, lithium bis(trifluoromethylsulfonyl)imide, lithium bis(pentafluoroethylsulfonyl)imide, tris(trifluoromethylsulfonyl)methyllithium, or lithium bis(trifluoromethylsulfonyl)imide.

Preferably, a concentration of the lithium salt in the electrolyte solution ranges from 1.0 mol/L to 1.5 mol/L.

Preferably, the organic solvent is selected from carbonate and/or carboxylate.

Preferably, the carbonate is selected from one or more of following fluorinated or unsubstituted solvents: ethylene carbonate (EC), propylene carbonate (PC), dimethyl carbonate, diethyl carbonate (DEC), or ethyl methyl carbonate.

Preferably, the carboxylate is selected from one or more of following fluorinated or unsubstituted solvents: propyl acetate, n-butyl acetate, isobutyl acetate, n-amyl acetate, isoamyl acetate, propyl propionate (PP), ethyl propionate (EP), methyl butyrate, or ethyl butyrate.

In a specific example provided in the present disclosure, when the organic solvent includes a plurality of components, the components may be combined in any proportion.

The present disclosure further provides a method for preparing an electrolyte solution, where an organic solvent, a lithium salt, an additive A, an additive B, and an additive C are mixed, to obtain the electrolyte solution.

In a specific example provided in the present disclosure, the electrolyte solution further includes an additive D, and the method for preparing an electrolyte solution includes: mixing an organic solvent, a lithium salt, an additive A, an additive B, an additive C, and the additive D, to obtain the electrolyte solution.

The present disclosure further provides a battery, including the foregoing electrolyte solution.

In an example provided in the present disclosure, the battery further includes a positive electrode plate, a negative electrode plate, and a separation film.

In an example provided in the present disclosure, the positive electrode plate includes a positive electrode current collector and a positive electrode active material layer coated on a surface of one side or surfaces of both sides of the positive electrode current collector; and the positive electrode active material layer includes a positive electrode active material, a conductive agent, and a binder.

Preferably, mass percentages of components in the positive electrode active material layer are: the positive electrode active material ranging from 80 wt % to 99.8 wt %, the conductive agent ranging from 0.1 wt % to 10 wt %, and the binder ranging from 0.1 wt % to 10 wt %.

Preferably, mass percentages of components in the positive electrode active material layer are: the positive electrode active material ranging from 90 wt % to 99.6 wt %, the conductive agent ranging from 0.2 wt % to 5 wt %, and the binder ranging from 0.2 wt % to 5 wt %.

In an example provided in the present disclosure, the negative electrode plate includes a negative electrode current collector and a negative electrode active material layer coated on a surface of one side or surfaces of both sides of the negative electrode current collector, and the negative electrode active material layer includes a negative electrode active material, a conductive agent, and a binder.

Preferably, mass percentages of components in the negative electrode active material layer are: the negative electrode active material ranging from 80 wt % to 99.8 wt %, the conductive agent ranging from 0.1 wt % to 10 wt %, and the binder ranging from 0.1 wt % to 10 wt %.

Preferably, mass percentages of components in the negative electrode active material layer are: the negative electrode active material ranging from 90 wt % to 99.6 wt %, the conductive agent ranging from 0.2 wt % to 5 wt %, and the binder ranging from 0.2 wt % to 5 wt %.

Preferably, the negative electrode active material includes a carbon-based negative electrode material.

Preferably, the carbon-based negative electrode material includes at least one of artificial graphite, natural graphite, mesocarbon microbead, hard carbon, or soft carbon.

In an example provided in the present disclosure, the negative electrode active material may further include a silicon-based negative electrode material.

In a specific example provided in the present disclosure, the silicon-based negative electrode material is selected from at least one of nano-silicon, a silicon-oxygen negative electrode material (SiOₓ(0<x<2)), or a silicon-carbon negative electrode material.

In a specific example provided in the present disclosure, in the negative electrode active material, a mass ratio of the carbon-based negative electrode material to the silicon-based negative electrode material is 10:0 to 1:19, for example, 1:19, 1:18, 1:17, 1:16, 1:15, 1:14, 1:13, 1:12, 1:11, 1:10, 1:9, 2:8, 3:7, 4:6, 5:5, 6:4, 7:3, 8:2, 9:1, or 10:0.

Preferably, the positive electrode active material is selected from one or more of a transition metal lithium oxide, lithium iron phosphate, or lithium manganese oxide; a chemical formula of the transition metal lithium oxide is Li₁₊ₓNi_{y}Co_{z}M_{(1-y-z)}O₂, where −0.1≤x≤1; 0≤y≤1, 0≤z≤1, and 0≤y+z≤1; and M is one or more of Mg, Zn, Ga, Ba, Al, Fe, Cr, Sn, V, Mn, Sc, Ti, Nb, Mo, or Zr.

Preferably, the conductive agent is selected from at least one of conductive carbon black, acetylene black, Ketjen black, conductive graphite, conductive carbon fiber, carbon nanotube, metal powder, or carbon fiber.

Preferably, the binder is selected from at least one of sodium carboxymethyl cellulose, styrene-butadiene rubber, polytetrafluoroethylene, or polyethylene oxide.

In a specific example provided in the present disclosure, the battery further includes outer packaging.

In a specific example provided in the present disclosure, a method for preparing a battery is: stacking a positive electrode plate, a separation film, and a negative electrode plate to obtain a battery core, or disposing a positive electrode plate, a separation film, and a negative electrode plate, then winding them to obtain a battery core, placing the battery core in the outer packaging, and injecting an electrolyte solution into the outer packaging, to obtain the battery of the present disclosure.

Further, the additive C (the bis(fluorosulfonyl)imide salt) in the present invention is a positive electrode protection additive that can continuously perform repairment on the surface of the positive electrode in a later stage of a cycle, thereby improving film forming stability of the additive A at the positive electrode, and further improving high-temperature performance of the battery in the later stage of the cycle. Furthermore, the combination of the additive A, the additive B, and the additive C in the present disclosure meets the following relational expression:

0.36≤(C_{B}+0.5C_{A})/(C_{C}−0.5C_{A})≤4,

where C_{A} is a mass percentage value of the additive A, C_{B} is a mass percentage value of the additive B, and C_{C} is a mass percentage value of the additive C, where 1≤A≤4, 0.1≤B≤3, and 2≤C≤7.

When the foregoing relational expression is met, it can be ensured that the additive A, the additive B, and the additive C all reach appropriate relative percentages, so that both the positive and negative electrodes achieve optimum film forming stability. In this case, a barrier effect is effectively achieved, and optimum security performance of the battery is significantly achieved.

All reagents, materials, and the like used in the present disclosure can be commercially obtained.

The present disclosure is further described below in combination with examples:

### Examples 1 to 26 and Comparative Examples 1 to 8

A lithium-ion battery is prepared based on following steps.

### (1) Preparation of a Positive Electrode Plate

Positive electrode active materials, namely, lithium cobalt oxides (LiCoO₂), polyvinylidene fluoride (PVDF), SP (super P), and carbon nanotubes (CNT), were mixed in a mass ratio of 96:2:1.5:0.5, and N-methylpyrrolidone (NMP) was added. Stirring was performed in a vacuum mixer until a mixture became a positive electrode active slurry with uniform fluidity. The positive electrode active slurry was evenly coated on both surfaces of an aluminum foil. A coated aluminum foil was dried, and then rolled and cut to obtain the required positive electrode plate.

### (2) Preparation of a Negative Electrode Plate

Negative electrode active materials, namely, artificial graphite, silicon monoxide, sodium carboxymethyl cellulose (CMC-Na), styrene-butadiene rubber, conductive carbon black (SP), and single-walled carbon nanotubes (SWCNTs), were mixed in a mass ratio of 79.5:15:2.5:1.5:1:0.5, deionized water was added, and a negative electrode active slurry was obtained under an action of a vacuum mixer. The negative electrode active slurry was evenly coated on both surfaces of a copper foil. A coated copper foil was aired at a room temperature, transferred to an 80° C. oven for drying for 10 hours, and then cold-pressed and cut to obtain the negative electrode plate.

### (3) Preparation of an Electrolyte Solution

In a glove box filled with argon (H₂O<0.1 ppm and O₂<0.1 ppm), EC, PC, DEC, and PP were mixed evenly in a mass ratio of 10/20/10/60, and then 1 mol/L of fully dried lithium hexafluorophosphate (LiPF₆) was quickly added thereto. After dissolution, 8 wt % of fluoroethylene carbonate and 2 wt % of 1-propene 1,3-sultone based on a total mass of the electrolyte solution were added, and then the additive A (a compound shown in the structural formula 6), the additive B (ADN/HTCN=1/1), and the additive C (lithium bis(fluorosulfonyl)imide) were added. A quantity of each additive to be added was shown in Table 1. (In the example 25, based on the original additives A, B and C, an additive D was added: fluoroethylene carbonate/1-propene 1,3-sultone=1/1).

A specific formula of the electrolyte solution in the examples and the comparative examples are as follows:

TABLE 1
Composition of additives in the electrolyte solution in the lithium-ion battery in the examples and the comparative examples

| | | | | Content | Content | Content | | | |
|---|---|---|---|---|---|---|---|---|---|
| | | | | (%) of | (%) of | (%) of | | | (C_{B} + 0.5C_{A})/ |
| | Additive | Additive | | the | the additive | additive | C_{B} + | C_{B} − | (C_{C} − |
| Group | A | B | Additive C | additive A | B | the C | 0.5CA | 0.5C_{A} | 0.5C_{A}) |
| Example | Structural | ADN/H | Lithium | 3 | 0.5 | 3 | 2 | 1.5 | 1.3 |
| 1 | formula 6 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 2 | formula 1 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 3 | formula 2 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 4 | formula 3 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 5 | formula 4 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 6 | formula 5 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 7 | formula 7 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 8 | formula 8 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 9 | formula 9 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 10 | formula | TCN = | bis(fluorosulfonyl)imide | | | | | | |
| | 10 | 1/1 | | | | | | | |
| Example | Structural | ADN/H | Lithium | 3 | 0.5 | 3 | 2 | 1.5 | 1.3 |
| 11 | formula | TCN = | bis(fluorosulfonyl)imide | | | | | | |
| | 11 | 1/1 | | | | | | | |
| Example | Structural | ADN/H | Lithium | 3 | 0.5 | 3 | 2 | 1.5 | 1.3 |
| 12 | formula | TCN = | bis(fluorosulfonyl)imide | | | | | | |
| | 12 | 1/1 | | | | | | | |
| Example | Structural | ADN | Lithium | 3 | 0.5 | 3 | 2 | 1.5 | 1.3 |
| 13 | formula 6 | | bis(fluorosulfonyl)imide | | | | | | |
| Example | Structural | HTCN | Lithium | 3 | 0.5 | 3 | 2 | 1.5 | 1.3 |
| 14 | formula 6 | | bis(fluorosulfonyl)imide | | | | | | |
| Example | Structural | ADN/H | Sodium | 3 | 0.5 | 3 | 2 | 1.5 | 1.3 |
| 15 | formula 6 | TCN = | bis(fluorosulfonyl)imide | | | | | | |
| | | 1/1 | | | | | | | |
| Example | Structural | ADN/H | Lithium | 2 | 0.5 | 3 | 1.5 | 2 | 0.8 |
| 16 | formula 6 | TCN = | bis(fluorosulfonyl)imide | | | | | | |
| | | 1/1 | | | | | | | |
| Example | Structural | ADN/H | Lithium | 1 | 0.5 | 3 | 1 | 2.5 | 0.4 |
| 17 | formula 6 | TCN = | bis(fluorosulfonyl)imide | | | | | | |
| | | 1/1 | | | | | | | |
| Example | Structural | ADN/H | Lithium | 4 | 0.5 | 3 | 2.5 | 1 | 2.5 |
| 18 | formula 6 | TCN = | bis(fluorosulfonyl)imide | | | | | | |
| | | 1/1 | | | | | | | |
| Example | Structural | ADN/H | Lithium | 3 | 0.1 | 3 | 1.6 | 1.5 | 1.1 |
| 19 | formula 6 | TCN = | bis(fluorosulfonyl)imide | | | | | | |
| | | 1/1 | | | | | | | |
| Example | Structural | ADN/H | Lithium | 3 | 1 | 3 | 2.5 | 1.5 | 1.7 |
| 20 | formula 6 | TCN = | bis(fluorosulfonyl)imide | | | | | | |
| | | 1/1 | | | | | | | |
| Example | Structural | ADN/H | Lithium | 3 | 3 | 3 | 4.5 | 1.5 | 3 |
| 21 | formula 6 | TCN = | bis(fluorosulfonyl)imide | | | | | | |
| | | 1/1 | | | | | | | |
| Example | Structural | ADN/H | Lithium | 3 | 0.5 | 2 | 2 | 0.5 | 4 |
| 22 | formula 6 | TCN = | bis(fluorosulfonyl)imide | | | | | | |
| | | 1/1 | | | | | | | |
| Example | Structural | ADN/H | Lithium | 3 | 0.5 | 5 | 2 | 3.5 | 0.6 |
| 23 | formula 6 | TCN = | bis(fluorosulfonyl)imide | | | | | | |
| | | 1/1 | | | | | | | |
| Example | Structural | ADN/H | Lithium | 3 | 0.5 | 7 | 2 | 5.5 | 0.4 |
| 24 | formula 6 | TCN = | bis(fluorosulfonyl)imide | | | | | | |
| | | 1/1 | | | | | | | |
| Example | Structural | ADN/H | Lithium | 3 | 0.5 | 3 | 2 | 1.5 | 1.3 |
| 25 | formula 6 | TCN = | bis(fluorosulfonyl)imide | | | | | | |
| | | 1/1 | | | | | | | |
| Example | Structural | ADN/H | Lithium | 3 | 0.5 | 8 | 2 | 6.5 | 0.3 |
| 26 | formula 6 | TCN = | bis(fluorosulfonyl)imide | | | | | | |
| | | 1/1 | | | | | | | |
| Compar- | | ADN/H | Lithium | 0 | 0.5 | 3 | 0.5 | 3 | 0.2 |
| ative | | TCN = | bis(fluorosulfonyl)imide | | | | | | |
| example | | 1/1 | | | | | | | |
| 1 | | | | | | | | | |
| Compar- | Structural | ADN/H | Lithium | 5 | 0.5 | 3 | 3 | 0.5 | 6 |
| ative | formula 6 | TCN = | bis(fluorosulfonyl)imide | | | | | | |
| example | | 1/1 | | | | | | | |
| 2 | | | | | | | | | |
| Compar- | Structural | / | Lithium | 3 | 0 | 3 | 1.5 | 1.5 | 1 |
| ative | formula 6 | | bis(fluorosulfonyl)imide | | | | | | |
| example | | | | | | | | | |
| 3 | | | | | | | | | |
| Compar- | Structural | ADN/H | Lithium | 3 | 4 | 3 | 5.5 | 1.5 | 3.7 |
| ative | formula 6 | TCN = | bis(fluorosulfonyl)imide | | | | | | |
| example | | 1/1 | | | | | | | |
| 4 | | | | | | | | | |
| Compar- | Structural | ADN/H | / | 3 | 0.5 | 0 | 2 | −1.5 | −1.3 |
| ative | formula 6 | TCN = | | | | | | | |
| example | | 1/1 | | | | | | | |
| 5 | | | | | | | | | |
| Compar- | Structural | / | / | 1 | 0 | 0 | 0.5 | −0.5 | −1 |
| ative | formula 6 | | | | | | | | |
| example | | | | | | | | | |
| 6 | | | | | | | | | |
| Compar- | / | / | Lithium | 0 | 0 | 2 | 0 | 2 | 0 |
| ative | | | bis(fluorosulfonyl)imide | | | | | | |
| example | | | | | | | | | |
| 7 | | | | | | | | | |
| Compar- | / | / | / | 0 | 0 | 0 | 0 | 0 | / |
| ative | | | | | | | | | |
| example | | | | | | | | | |
| 8 | | | | | | | | | |

### (4) Preparation of a Lithium-Ion Battery

The positive electrode plate in step (1), the negative electrode plate in step (2), and the separation film were stacked in an order of the positive electrode plate, the separation film, and the negative electrode plate, and then wound to obtain a battery core. The battery core was placed in an aluminum foil of the outer packaging, the electrolyte solution in step (3) was injected into the outer packaging, and the lithium-ion battery was obtained after vacuum packaging, static placement, formation, shaping, sorting, and other processes.

### Performance Test 1 of the Lithium-Ion Battery

The performance test was performed on the lithium-ion battery prepared based on the examples and the comparative examples above, and a battery charge and discharge range is 3.0 V to 4.5 V. The results are shown in Table 2.

### (1) Test of High-Temperature Cycling Performance at 45° C.

The battery is charged and discharged for 800 cycles at 45° C. at a rate of 1C within a charge and discharge cut-off voltage range. A discharge capacity in the first cycle is tested and recorded as ×1 mAh, and a discharge capacity in the N^{th} cycle is recorded as y1 mAh. The capacity in the N^{th} cycle is divided by the discharge capacity in the first cycle to obtain a cycling capacity retention rate, that is, R₁=y1/x1.

### (2) Security Performance Test

A battery core at 0.5C was charged to an upper cut-off voltage that was kept constant at 0.05C. At an ambient temperature of 25° C.±5° C., a fully charged sample was placed in a heat shock test chamber, then a temperature was raised to 140° C.±2° C. at a rate of 15° C.±2° C./min, and this temperature was maintained for 42 minutes before the test ended. Whether the battery catches fire or explodes was observed. If there was no fire or explosion, security performance was expressed as “safe” and indicated by OK. If there was only fire, security performance was expressed as “fire”. If there was only an explosion, security performance was expressed as an “explosion”. If there was both fire and an explosion, security performance was expressed as “fire and explosion” that were both expressed as NG.

TABLE 2
Performance test results of the lithium-ion battery in the examples and the comparative examples

| | | | | High-temperature storage at 85° C. | | |
|---|---|---|---|---|---|---|
| | | | | | Thickness | Security |
| | | | | Capacity | performance | performance |
| | Cycling capacity retention rate (%) at 45° C. | | | retention | expansion | test at |
| Group | 300 cycles | 500 cycles | 800 cycles | rate (%) | rate (%) | 130° C. |
| Example 1 | 97.47 | 95.85 | 87.88 | 91.01 | 1.95 | OK |
| Example 2 | 92.70 | 85.19 | 79.08 | 87.05 | 6.95 | OK |
| Example 3 | 91.17 | 84.05 | 77.74 | 85.91 | 8.09 | OK |
| Example 4 | 91.41 | 83.94 | 78.12 | 85.80 | 8.20 | OK |
| Example 5 | 93.78 | 86.78 | 79.93 | 88.64 | 5.36 | OK |
| Example 6 | 92.70 | 85.19 | 79.08 | 87.05 | 6.95 | OK |
| Example 7 | 99.11 | 96.89 | 89.07 | 92.21 | 1.25 | OK |
| Example 8 | 91.31 | 83.45 | 78.47 | 84.82 | 9.18 | OK |
| Example 9 | 91.50 | 83.74 | 78.54 | 85.11 | 8.89 | OK |
| Example 10 | 91.16 | 83.59 | 77.92 | 84.96 | 9.04 | OK |
| Example 11 | 91.47 | 83.84 | 78.53 | 85.21 | 8.79 | OK |
| Example 12 | 91.32 | 83.74 | 76.49 | 85.11 | 8.89 | OK |
| Example 13 | 95.23 | 93.22 | 85.19 | 90.23 | 2.23 | OK |
| Example 14 | 95.38 | 93.38 | 85.41 | 90.33 | 2.19 | OK |
| Example 15 | 94.19 | 92.89 | 84.21 | 89.21 | 3.31 | OK |
| Example 16 | 96.47 | 92.48 | 83.82 | 91.01 | 2.11 | OK |
| Example 17 | 93.3 | 89.56 | 78.01 | 89.72 | 7.92 | OK |
| Example 18 | 93.46 | 89.47 | 80.81 | 88 | 5.12 | OK |
| Example 19 | 91 | 89.38 | 81.41 | 84.54 | 4.52 | OK |
| Example 20 | 95.42 | 93.8 | 85.83 | 88.96 | 0.11 | OK |
| Example 21 | 92.57 | 90.95 | 82.99 | 86.12 | 2.95 | OK |
| Example 22 | 94.23 | 89.51 | 78.75 | 89.64 | 7.19 | OK |
| Example 23 | 94.02 | 89.23 | 78.46 | 89.43 | 7.48 | OK |
| Example 24 | 90.4 | 82.69 | 68.5 | 87.69 | 10.44 | OK |
| Example 25 | 96.38 | 94.27 | 86.16 | 89.73 | 0.12 | OK |
| Example 26 | 83.26 | 69.34 | 49.06 | 84.29 | 11.6 | NG |
| Comparative example 1 | 81.48 | 74.95 | 60.46 | 79.77 | 25.47 | NG |
| Comparative example 2 | 89.64 | 85.66 | 77 | 84.19 | 8.94 | NG |
| Comparative example 3 | 83.92 | 82.3 | 74.34 | 77.47 | 11.6 | NG |
| Comparative example 4 | 88.52 | 86.9 | 78.94 | 82.07 | 7 | NG |
| Comparative example 5 | 90.42 | 88.8 | 80.84 | 83.97 | 5.1 | NG |
| Comparative example 6 | 89.31 | 82.78 | 68.29 | 87.59 | 17.65 | NG |
| Comparative example 7 | 85.86 | 78.86 | 64.41 | 83.97 | 21.53 | NG |
| Comparative example 8 | 63.56 | 48.89 | 28.93 | 53.42 | 47.36 | NG |

The foregoing descriptions are merely preferred embodiments of the present disclosure. It should be noted that a person of ordinary skill in the art may make several improvements or polishing without departing from the principle of the present disclosure, and the improvements or polishing shall also fall within the protection scope of the present disclosure.

What is claimed is:

1. An electrolyte solution, wherein the electrolyte solution comprises an organic solvent, a lithium salt, an additive A, an additive B, and an additive C, wherein
the additive A is carbon-linked disulfonate;
the additive B is a polycyano nitrile compound; and
the additive C is a bis(fluorosulfonyl)imide salt.

2. The electrolyte solution according to claim 1, wherein the additive A has a following general structural formula: 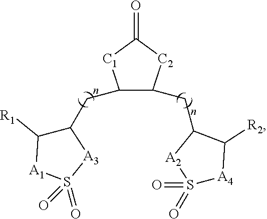
wherein R₁ and R₂ are independently selected from:
an alkane group, an alkene group, and an alkyne group of C1 to C20 substituted or unsubstituted by halogen,
a cycloalkyl group of C3 to C20 substituted or unsubstituted by halogen,
a phenyl group substituted or unsubstituted by halogen,
a biphenylyl group substituted or unsubstituted by halogen,
a benzene alkyl group of C6 to C26 substituted or unsubstituted by halogen,
a polycyclic aromatic hydrocarbon group of C6 to C26 substituted or unsubstituted by halogen, and
a hydrogen or halogen, wherein
A₁, A₂, A₃, A₄, C₁, and C₂ are independently selected from C, S, N, and O; and
N is a quantity of carbon atoms that ranges from 0 to 2.

3. The electrolyte solution according to claim 1, wherein the additive A has a following general structural formula: 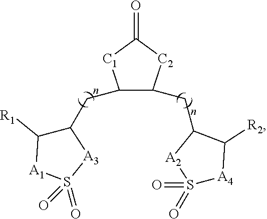
wherein R₁ and R₂ are independently selected from: hydrogen, methyl, ethyl, n-propyl, isopropyl, n-butyl, and tert-butyl, wherein
A₁ and A₄ are independently selected from C, N, and O; A₂, A₃, C₁, and C₂ are independently selected from N and O; and
n is 1.

4. The electrolyte solution according to claim 3, wherein R₁ and R₂ are independently selected from:
an alkane group of C1 to C8, an alkene group of C1 to C8, and an alkyne group of C1 to C8 each substituted or unsubstituted by halogen,
a cycloalkyl group of C3 to C8 substituted or unsubstituted by halogen,
a phenyl group substituted or unsubstituted by halogen,
a biphenylyl group substituted or unsubstituted by halogen,
a benzene alkyl group of C6 to C8 substituted or unsubstituted by halogen,
a polycyclic aromatic hydrocarbon group of C10 to C14 substituted or unsubstituted by halogen, and
a hydrogen or halogen.

5. The electrolyte solution according to claim 3, wherein R₁ and R₂ are independently selected from:
an alkane group of C1 to C6 substituted or unsubstituted by halogen, and
a hydrogen or halogen.

6. The electrolyte solution according to claim 1, wherein the additive A comprises at least one of following structural formulas 1 to 12:

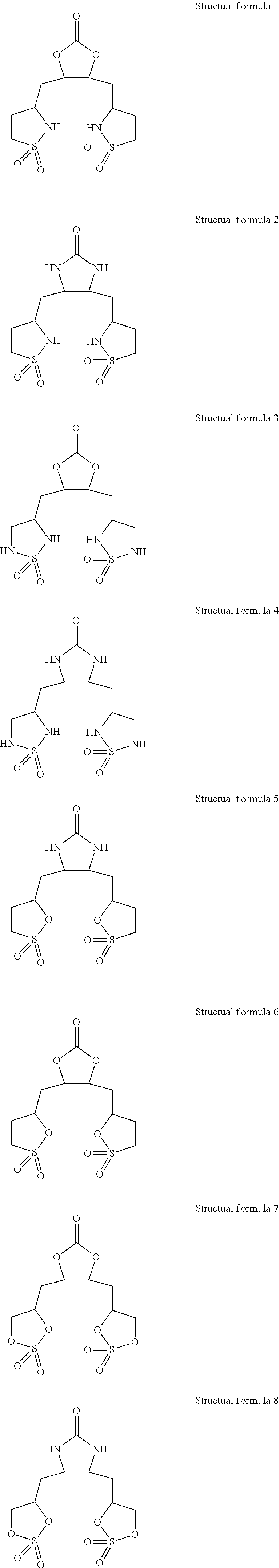

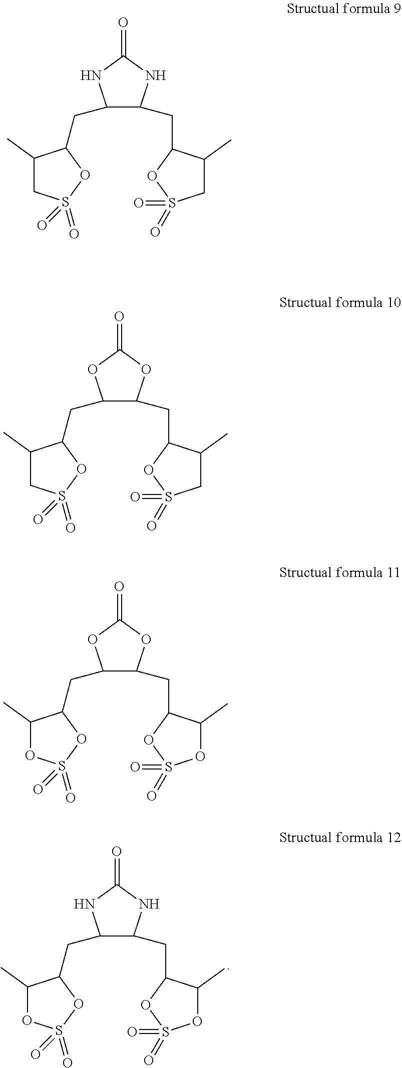

7. The electrolyte solution according to claim 1, wherein the polycyano nitrile compound comprises at least one of succinonitrile, glutaronitrile, adiponitrile, suberonitrile, sebaconitrile, 3-methoxypropionitrile, ethylene glycol bis(propionitrile) ether, 1,3,6-hexanetricarbonitrile, 1,2,3-tris-(2-cyanoethoxy)propane, 1,3,5-pentanetricarbonitrile, 2,2-difluorosuccinonitrile, 2-fluoroadiponitrile, or tricyanobenzene;
and/or, a structural formula of the bis(fluorosulfonyl)imide salt is shown below: 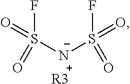
wherein R₃ is selected from one of Li, Na, K, Rb, Cs, or Fr.

8. The electrolyte solution according to claim 1, wherein the polycyano nitrile compound comprises at least one of a composition of adiponitrile and 1,3,6-hexanetricarbonitrile, a composition of succinonitrile and 1,3,6-hexanetricarbonitrile, or a composition of succinonitrile and adiponitrile;
and/or, the bis(fluorosulfonyl)imide salt comprises at least one of lithium bis(fluorosulfonyl)imide, sodium bis(fluorosulfonyl)imide, potassium bis(fluorosulfonyl)imide, rubidium bis(fluorosulfonyl)imide, or cesium bis(fluorosulfonyl)imide.

9. The electrolyte solution according to claim 8, wherein a mass ratio of adiponitrile to 1,3,6-hexanetricarbonitrile is (1 to 100):(1 to 100).

10. The electrolyte solution according to claim 1, wherein based on a total weight of the electrolyte solution, a content of the additive A ranges from 0.1 wt % to 5.0 wt %;
a content of the additive B ranges from 0.1 wt % to 5.0 wt %; and
a content of the additive C ranges from 0.5 wt % to 10 wt %.

11. The electrolyte solution according to claim 1, wherein based on a total weight of the electrolyte solution, a content of the additive A ranges from 1.0 wt % to 4.0 wt %;
a content of the additive B ranges from 0.1 wt % to 3.0 wt %; and
a content of the additive C ranges from 2.0 wt % to 7.0 wt %.

12. The electrolyte solution according to claim 1, wherein the electrolyte solution meets a following relational expression:
0.36≤(C_{B}+0.5C_{A})/(C_{C}−0.5C_{A})≤4
wherein C_{A} is a mass percentage value of the additive A in the electrolyte solution, C_{B} is a mass percentage value of the additive B in the electrolyte solution, and C_{C} is a mass percentage value of the additive C in the electrolyte solution, wherein 1≤C_{A}≤4, 0.1≤C_{B}≤3, and 2≤C_{C}≤7.

13. The electrolyte solution according to claim 1, wherein the electrolyte solution further comprises an additive D, and the additive D comprises at least one of fluoroethylene carbonate, 1-propene 1,3-sultone, ethylene sulfate, lithium difluorooxalatoborate, lithium difluorophosphate, or lithium bisoxalatodifluorophosphate.

14. The electrolyte solution according to claim 13, wherein the additive D comprises fluoroethylene carbonate and 1-propene 1,3-sultone.

15. The electrolyte solution according to claim 14, wherein based on a total weight of the electrolyte solution, a content of fluoroethylene carbonate ranges from 1 wt % to 10 wt %; and/or,
based on a total weight of the electrolyte solution, a content of 1-propene 1,3-sultone ranges from 1 wt % to 3 wt %.

16. The electrolyte solution according to claim 1, wherein the lithium salt is selected from at least one of lithium hexafluorophosphate, lithium difluorophosphate, lithium difluorooxalatoborate, lithium bis(trifluoromethylsulfonyl)imide, lithium difluorobis(oxalato)phosphate, lithium tetrafluoroborate, lithium bis(oxalatoborate), lithium hexafluoroantimonate, lithium hexafluoroarsenate, lithium bis(trifluoromethylsulfonyl)imide, lithium bis(pentafluoroethylsulfonyl)imide, tris(trifluoromethylsulfonyl)methyllithium, or lithium bis(trifluoromethylsulfonyl)imide.

17. The electrolyte solution according to claim 16, wherein a concentration of the lithium salt in the electrolyte solution ranges from 1.0 mol/L to 1.5 mol/L.

18. The electrolyte solution according to claim 1, wherein the organic solvent is selected from carbonate and/or carboxylate.

19. The electrolyte solution according to claim 18, wherein the carbonate is selected from one or more of following fluorinated or unsubstituted solvents: ethylene carbonate, propylene carbonate, dimethyl carbonate, diethyl carbonate, or ethyl methyl carbonate; and/or,
the carboxylate is selected from one or more of following fluorinated or unsubstituted solvents: propyl acetate, n-butyl acetate, isobutyl acetate, n-amyl acetate, isoamyl acetate, propyl propionate, ethyl propionate, methyl butyrate, or ethyl butyrate.

20. A battery, comprising the electrolyte solution according to claim 1.
